(19) United States
(12) Patent Application Publication
(10) Pub. No.: US 2023/0278858 A1
(43) Pub. Date: Sep. 7, 2023

(54) CATALYST FOR NON-OXIDATIVE CONVERSION OF HYDROCARBONS TO HYDROGEN

(71) Applicant: CHEVRON U.S.A. INC., San Ramon, CA (US)

(72) Inventors: Xiaoying Ouyang, San Ramon, CA (US); Alexander Kuperman, San Ramon, CA (US); Huping Luo, San Ramon, CA (US); Lin Li, San Ramon, CA (US)

(21) Appl. No.: 18/116,214

(22) Filed: Mar. 1, 2023

Related U.S. Application Data
(60) Provisional application No. 63/315,282, filed on Mar. 1, 2022.

(51) Int. Cl. C01B 3/26; B01J 23/745; B01J 21/08; B01J 21/06; B01J 27/224; B01J 23/06; B01J 21/04; B01J 23/755; B01J 29/46; B01J 23/83; B01J 37/08; B01J 37/06; B01J 37/02; B01J 35/04

(52) U.S. Cl. CPC C01B 3/26; B01J 23/745; B01J 21/08; B01J 21/063; B01J 27/224; B01J 23/06; B01J 21/04; B01J 23/755; B01J 29/46; B01J 23/83; B01J 37/086; B01J 37/06; B01J 37/0201; B01J 35/04; B01J 37/0236; C01B 2203/1241; C01B 2203/1058; C01B 2203/1076

(57) ABSTRACT

The present disclosure refers to systems, methods, and catalysts for conversion of a hydrocarbon to hydrogen. The catalyst typically comprises a matrix comprising fused silica, quartz, glass, a zeolite, Si₃N₄, SiC, SiCₓO_{y} wherein 4x+2y =4, SiOₐN_{b} wherein 2a+3b =4, BN, TiO₂, ZrO₂, Al₂O₃, CeO₂, Nb₂O₅, La₂O₃, a perovskite, or any mixture thereof. A metal dopant is embedded in the matrix. The metal dopant comprises Fe, Ni, Co, Cu, Zn, Mn, or any mixture thereof.

### FIELD OF THE DISCLOSURE

The present disclosure relates to systems, methods, and catalysts for non-oxidative production of hydrogen from hydrocarbons such as natural gas.

### BACKGROUND AND SUMMARY

Hydrogen is one of the more important options for future clean energy. Unfortunately, many commercially available technologies like steam methane reforming to produce hydrogen are carbon intensive. While using carbon capture and storage may reduce the carbon footprint, the available processes are often energy intensive. What is needed is a solution that produces hydrogen without being carbon intensive. It would further be advantageous if such a solution were relatively energy efficient and cost-efficient.

Advantageously, the instant application pertains to new systems, methods, and catalysts that may non-oxidatively produce hydrogen from hydrocarbons such as natural gas. The solutions are not substantially carbon intensive, are energy efficient, and/or are cost-efficient.

The instant application pertains in one embodiment to a catalyst for non-oxidative conversion of a hydrocarbon to hydrogen. The catalyst comprises a matrix comprising fused silica, quartz, glass, a zeolite, Si₃N₄, SiC, SiCₓO_{y} wherein 4x+2y=4, SiOₐN_{b} wherein 2a+3b=4, BN, TiO₂, ZrO₂, Al₂O₃, CeO₂, Nb₂O₅, La₂O₃, a perovskite, or any mixture thereof. A metal dopant is embedded in the matrix wherein the metal dopant comprises Fe, Ni, Co, Cu, Zn, Mn, or any mixture thereof. The catalyst is not the product of fusing ferrous metasilicate with SiO₂ at a temperature of 500° C. to 2400° C.

In another embodiment the instant application pertains to a process for the preparation of a catalyst. The process comprises doping a metal in a matrix material wherein the metal comprises Fe, Ni, Co, Cu, Zn, Mn, or any mixture thereof. The matrix comprises fused silica, quartz, glass, a zeolite, Si₃N₄, SiC, SiCₓO_{y} wherein 4x+2y=4, SiOₐN_{b} wherein 2a+3b=4, BN, TiO₂, ZrO₂, Al₂O₃, CeO₂, Nb₂O₅, La₂O₃, a perovskite, or any mixture thereof. The doping excludes fusing ferrous metasilicate with SiO₂ at a temperature of 500° C. to 2400° C.

In another embodiment the instant application pertains to a process for non-oxidative conversion of a hydrocarbon to hydrogen. The process comprises contacting the hydrocarbon with a catalyst under conditions to convert the hydrocarbon to hydrogen. The catalyst comprises a matrix comprising fused silica, quartz, glass, a zeolite, Si₃N₄, SiC, SiCₓO_{y} wherein 4x+2y=4, SiOₐN_{b} wherein 2a+3b=4, BN, TiO₂, ZrO₂, Al₂O₃, CeO₂, Nb₂O₅, La₂O₃, a perovskite, or any mixture thereof. A metal dopant is embedded in the matrix wherein the metal dopant comprises Fe, Ni, Co, Cu, Zn, Mn, or any mixture thereof. The catalyst is not the product of fusing ferrous metasilicate with SiO₂ at a temperature of 500° C. to 2400° C.

These and other objects, features and advantages of the exemplary embodiments of the present disclosure will become apparent upon reading the following detailed description of the exemplary embodiments of the present disclosure, when taken in conjunction with the appended claims.

### DETAILED DESCRIPTION

The following description of embodiments provides a non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

### Novel Catalysts and Processes of Preparing Catalysts

The instant application pertains in one embodiment to novel catalysts for non-oxidative conversion of a hydrocarbon to hydrogen. The catalysts typically comprise a matrix and a metal dopant.

The matrix employed for the catalyst may vary depending upon desired use, metal dopant, and/or other factors. Typically, the matrix comprises fused silica, quartz, glass, a zeolite, Si₃N₄, SiC, SiCₓO_{y} wherein 4x+2y=4, SiOₐN_{b} wherein 2a+3b=4, BN, TiO₂, ZrO₂, Al₂O₃, CeO₂, Nb₂O₅, La₂O₃, a perovskite, or any mixture thereof. As used herein a perovskite refers to any material with a crystal structure similar to the mineral called perovskite. In some embodiments a perovskite has the chemical formula ABX₃ wherein A and B are two cations of very different sizes, and X is an anion such as oxygen that bonds to both.

The zeolite may be an MFI-type zeolite and/or may have a pore diameter of from 4 angstroms to 20 angstroms and/or have a Si/Al atomic ratio of from 5 to 300.

A metal dopant is typically embedded in the matrix. The metal dopant comprises Fe, Ni, Co, Cu, Zn, Mn, or any mixture thereof. In some embodiments the embedded metal dopant comprises isolated metal atoms that are substantially free of aggregates with a size larger than 1 nm and/or the embedded metal dopant comprises isolated metal atoms in an amount that substantially reduces coking in a non-oxidative conversion of a hydrocarbon like natural gas or methane to hydrogen. The amount of isolated metal atoms is usually as high as reasonably possible and in some embodiments may be greater than about 40, or greater than about 50% of all embedded metal dopant. The catalyst is typically not a product of fusing ferrous metasilicate with SiO₂ at a temperature of 500° C. to 2400° C.

Any suitable process may be employed to produce the aforementioned novel catalysts. Typically, a suitable process comprises doping a metal in a matrix material wherein the metal comprises Fe, Ni, Co, Cu, Zn, Mn, or any mixture thereof and the matrix comprises fused silica, quartz, glass, a zeolite, Si₃N₄, SiC, SiCₓO_{y} wherein 4x+2y=4, SiOₐN_{b} wherein 2a+3b=4, BN, TiO₂, ZrO₂, Al₂O₃, CeO₂, Nb₂O₅, La₂O₃, a perovskite, or any mixture thereof.

The doping may be accomplished in a number of different manners which manner may be selected depending upon the available equipment, materials, desired catalyst, and other factors.

In one embodiment, the doping comprises ball milling the matrix material with one or more of SiO₂, B₂O₃, Fe₂O₃ or a mixture thereof to form a ball milled product; fusing the ball milled product to form a molten state and then cooling to form a cooled product; acid leaching the cooled product to remove at least a substantial portion of aggregated metals; and drying the acid leached product to form the catalyst.

In another embodiment, the doping comprises forming a gel. The process of forming the gel comprises combining a liquid source for the matrix formation with an inorganic metal salt or an inorganic metal alkoxide; and hydrolyzing to form the gel. The gel may be dried, fused, and acid leached to remove at least a substantial portion of aggregated metals. Further drying may be employed to form the catalyst.

In another embodiment, the doping comprises fusing a metal-containing zeolite; acid leaching the fused metal-containing zeolite to remove at least a substantial portion of aggregated metals; and drying the acid leached, fused metal-containing zeolite to form the catalyst.

In another embodiment, the doping comprises inserting the desired metal into a silanol nest within a silica matrix; fusing a metal to the matrix; acid leaching the fused metal matrix; and drying the acid leached, fused metal matrix to form the catalyst.

In another embodiment, the doping comprises subliming an organometallic precursor on a high surface area dehydroxylated silica to form a single site iron product; fusing a metal to the single site iron product; acid leaching the fused metal single site iron product; and drying the acid leached fused metal single site iron product to form the catalyst.

In another embodiment, the doping comprises washcoating a monolith catalyst support wherein the monolith comprises ceramic, silica, quartz, glass, metal, silicon carbide, silicon nitride, boron nitride, a metal oxide or any combination thereof; fusing a metal to the washcoated monolith catalyst support; acid leaching the fused washcoated monolith catalyst support; and drying the acid leached fused washcoated monolith catalyst support to form the catalyst. The metal oxide may be selected depending upon the desired catalyst and properties and may comprise titania, iron oxide, zirconia, a mixed metal oxide, or any combination thereof. In some embodiments the catalyst may be melted to form an amorphous, molten catalyst and then the amorphous, molten catalyst may be molded to obtain a desired shape such as, for example, a honeycomb monolith or a cylinder.

### Processes for Non-Oxidative Conversion of a Hydrocarbon to Hydrogen Using Novel Catalysts

The catalysts described above may be used in, for example, processes for non-oxidative conversion of a hydrocarbon such as natural gas to produce hydrogen and potentially other products. The process generally comprises contacting the hydrocarbon, e.g., natural gas, with a catalyst described above and/or a mixture of catalysts including one of the catalysts described above. The contacting is usually conducted under conditions to convert the hydrocarbon to hydrogen. The process may also produce a light hydrocarbon product such as ethylene, benzene, naphthalene, or any mixture thereof.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

### EXAMPLES

The following examples are provided as specific illustrations and are not meant to be limiting.

### Example 1

### 0.25% Fe/SiO₂ Catalyst

0.18 g Fe(NO₃)₃·9H₂O and 10 g technical grade silica gel with pore size 60 Å and 40-63 μm particle size were mixed and subjected to ball milling under air at 400 rev/min for 12 hours. Next, the mixture was pressed into a pellet in a die set using hydraulic press, and then calcined at 550° C. in air. The final catalyst was obtained after sizing it to 20-40 mesh.

### Example 2

### 0.5% Fe/SiO₂ Catalyst

0.36 g Fe(NO₃)₃·9H₂O and 10 g silica gel (high-purity grade Davisil Grade 643, 150 Å, 200-425 mesh) were mixed and subjected to ball milling under air at 400 rev/min for 12 hours. Next, the mixture was pressed into a pellet in a die set using a hydraulic press, and then calcined at 700° C. in air. The resulting sample was crushed and sieved to 100-200 mesh before leaching in an aqueous HNO₃ (1 mol/L) at 60° C. for 5 hours. The leached sample was dried at 130° C. overnight. The final loading of Fe was 0.37%.

### Example 3

### 0.5% Fe/TiO₂ Catalyst (Sample c)

This catalyst was prepared by an impregnation method. 10 g TiO₂ (HOMBIKAT 8602, Venator) was mixed with 0.36 g Fe(NO₃)₃·9H₂O dissolved in 10 g deionized water, and then aged for 24 hours. This mixture was then dried at 130° C. for 5 hours. Finally, the material was calcined at 550° C. for 4 hours. The resulting sample was crushed and sieved to 100-200 mesh before leaching in an aqueous HNO₃ (1 mol/L) at 60° C. for 5 hours. The leached sample was dried at 130 ° C. overnight. The final loading of Fe was 0.13%.

### Example 4

### BaCe_{0.9}Fe_{0.07}Co_{0.03}O₃ Catalyst

0.1 mol BaO₂, 0.9 mol CeO₂, 0.07 mol FeO, and 0.01 mol Co₃O₄ were mixed and subjected to ball milling under air at 400 rev/min for 24 hours. Next, the mixture was pressed into a pellet in a die set using a hydraulic press, and then calcined at 1000° C. in air for 8 hours. The calcined sample was crushed and subjected to ball milling under air at 400 rev/min for another 24 hours, followed by pressing pelletizing and calcination at 1000° C. in air for another 8 hours. The final catalyst was obtained after sizing to 40-60 mesh.

### Example 5

### 20% Zn/SiC Catalyst

40.5 g ZnO, 100 g SiC, and 10 g deionized water were mixed and subjected to ball milling under air at 450 rev/min for 4 hours. The mixture was filtered and dried at 130° C. for 4 hours to produce the final catalyst.

### Example 6

### 1% Ni/Al₂O₃ Catalyst

2000 g Al₂O₃ (Sasol PURALOX TH 100), 100 g Ni(NO₃)₂·6H₂O and 1600 g deionized water were blended at 60° C. in a Littleford mixer for 9 hours. The mixture was dried at 130° C. and then calcined at 600° C. for 2 hours.

### Example 7

### 0.75% Fe/SiO₂ Catalyst

0.11 g Fe₂O₃ and 10 g technical grade silica gel with pore size 60 Å and 40-63 μm particle size were mixed and subjected to ball milling under air at 400 rev/min for 12 hours. Next, the mixture was pressed into a pellet in a die set using hydraulic press, and then calcined at 1700° C. in N₂. The final catalyst was obtained after sizing to 20-40 mesh.

### Example 8

### 0.8% Fe/SiO₂ Catalyst

This catalyst was prepared using a sol-gel method. 51.6 g tetraethoxysilane (TEOS) was mixed with 662 mg Fe(NO₃)₃·9H₂O and 8 mL ethanol in 48 g aqueous nitric acid (15 wt. %), then stirred at 50° C. for 4 hours. The resulting gel was first dried in air at 130° C. for 3 hours and then heated at 1700° C. in N₂ for 2 hours.

### Example 9

### Catalytic Testing

Catalysts prepared in Examples 1-8 were tested for non-oxidative conversion of methane to hydrogen. Run conditions included a temperature of 1080° C. in a feed gas comprising 90% CH₄/10% N₂ at a total flow rate of 120 mL/min under ambient pressure. Catalytic testing results are reported in Table 1.

TABLE 1

| | | | Hydro- | |
|---|---|---|---|---|
| | | Methane | carbon | Coke |
| | | Conversion | Selectivity | Selectivity |
| | Catalyst | [%] | [%] | [%] |
| Ex. 1 | 0.25% Fe/SiO₂ | 20.1 | 34.9 | 65.1 |
| Ex. 2 | 0.5% Fe/SiO₂ | 17.9 | 31.5 | 68.5 |
| Ex. 3 | 0.5% Fe/TiO₂ | 10.1 | 18.7 | 81.3 |
| Ex. 4 | BaCe_{0.9}Fe_{0.07}Co_{0.03}O₃ | 4.6 | 4.8 | 95.2 |
| Ex. 5 | 20% Zn/SiC | 3.4 | 2.1 | 97.9 |
| Ex. 6 | 1% Ni/Al₂O₃ | 13.2 | 2.7 | 97.3 |
| Ex. 7 | 0.75% Fe/SiO₂ | 22.8 | 30.8 | 69.2 |
| Ex. 8 | 0.8% Fe/SiO₂ | 19.3 | 28.2 | 71.8 |

We claim:

1. A catalyst for non-oxidative conversion of a hydrocarbon to hydrogen, wherein the catalyst comprises:
a matrix comprising fused silica, quartz, glass, a zeolite, Si₃N₄, SiC, SiCₓO_{y} wherein 4x+2y=4, SiOₐN_{b} wherein 2a+3b=4, BN, TiO₂, ZrO₂, Al₂O₃, CeO₂, Nb₂O₅, La₂O₃, a perovskite, or any mixture thereof; and
a metal dopant embedded in the matrix wherein the metal dopant comprises Fe, Ni, Co, Cu, Zn, Mn, or any mixture thereof;
with the proviso that the catalyst is not the product of fusing ferrous metasilicate with SiO₂ at a temperature of 500° C. to 2400° C.

2. The catalyst of claim 1 wherein the embedded metal dopant comprises isolated metal atoms that are substantially free of aggregates.

3. The catalyst of claim 1 wherein the embedded metal dopant comprises isolated metal atoms in an amount that substantially reduces coking in non-oxidative conversion of hydrocarbon to hydrogen.

4. A process for the preparation of a catalyst comprising:
doping a metal in a matrix material wherein the metal comprises Fe, Ni, Co, Cu, Zn, Mn, or any mixture thereof;
wherein the matrix comprises fused silica, quartz, glass, a zeolite, Si₃N₄, SiC, SiCₓO_{y} wherein 4x+2y=4, SiOₐN_{b} wherein 2a+3b=4, BN, TiO₂, ZrO₂, Al₂O₃, CeO₂, Nb₂O₅, La₂O₃, a perovskite, or any mixture thereof;
with the proviso that the doping excludes fusing ferrous metasilicate with SiO₂ at a temperature of 500° C. to 2400° C.

5. The process of claim 4 wherein the doping comprises:
ball milling the matrix material with one or more of SiO₂, B₂O₃, Fe₂O₃ or a mixture thereof to form a ball milled product;
fusing the ball milled product to form a molten state and then cooling to form a cooled product;
acid leaching the cooled product to remove at least a substantial portion of aggregated metals; and
drying the acid leached product to form the catalyst.

6. The process of claim 4 wherein the doping comprises:
forming a gel wherein the process of forming the gel comprises:
combining a liquid source for the matrix formation with an inorganic metal salt or an inorganic metal alkoxide; and
hydrolyzing to form the gel;
drying the gel; and
fusing the dried gel;
acid leaching the fused, dried gel to remove at least a substantial portion of aggregated metals; and
drying the acid leached, fused, dried gel to form the catalyst.

7. The process of claim 4 wherein the doping comprises:
fusing a metal-containing zeolite;
acid leaching the fused metal-containing zeolite to remove at least a substantial portion of aggregated metals; and
drying the acid leached, fused metal-containing zeolite to form the catalyst.

8. The process of claim 4 wherein the doping comprises:
inserting the metal into a silanol nest within a silica matrix;
fusing a metal to the matrix;
acid leaching the fused metal matrix; and
drying the acid leached, fused metal matrix to form the catalyst.

9. The process of claim 4 wherein the doping comprises:
subliming an organometallic precursor on a high surface area dehydroxylated silica to form a single site iron product;
fusing a metal to the single site iron product;
acid leaching the fused metal single site iron product; and
drying the acid leached fused metal single site iron product to form the catalyst.

10. The process of claim 4 wherein the doping comprises:
washcoating a monolith catalyst support wherein the monolith comprises ceramic, silica, quartz, glass, metal, silicon carbide, silicon nitride, boron nitride, a metal oxide or any combination thereof;
fusing a metal to the washcoated monolith catalyst support;
acid leaching the fused washcoated monolith catalyst support; and
drying the acid leached fused washcoated monolith catalyst support to form the catalyst.

11. The process of claim 10 wherein the metal oxide comprises titania, iron oxide, zirconia, a mixed metal oxide, or any combination thereof.

12. The process of claim 10 further comprising melting the catalyst to form an amorphous, molten catalyst and molding the amorphous, molten catalyst to obtain the desired shape.

13. The process of claim 12 wherein the desired shape comprises a honeycomb monolith.

14. The process of claim 12 wherein the desired shape comprises a cylinder.

15. A process for non-oxidative conversion of a hydrocarbon to hydrogen comprising:
contacting the hydrocarbon with a catalyst under conditions to convert the hydrocarbon to hydrogen;
wherein the catalyst comprises a matrix comprising fused silica, quartz, glass, a zeolite, Si₃N₄, SiC, SiCₓO_{y} wherein 4x+2y=4, SiOₐN_{b} wherein 2a+3b=4, BN, TiO₂, ZrO₂, Al2O3, CeO₂, Nb₂O₅, La₂O₃, a perovskite, or any mixture thereof; and
a metal dopant embedded in the matrix wherein the metal dopant comprises Fe, Ni, Co, Cu, Zn, Mn, or any mixture thereof;
with the proviso that the catalyst is not the product of fusing ferrous metasilicate with SiO₂ at a temperature of 500° C. to 2400° C.

16. The process of claim 15 wherein the process further comprises producing a light hydrocarbon product.

17. The process of claim 16 wherein the light hydrocarbon product comprises ethylene, benzene, naphthalene, or any mixture thereof.

18. The process of claim 15 wherein the hydrocarbon comprises natural gas.

19. The process of claim 15 wherein the zeolite is an MFI-type zeolite.

20. The process of claim 15 wherein the zeolite comprises a pore diameter of from 4 angstroms to 20 angstroms.

21. The process of claim 15 wherein the zeolite has a Si/Al atomic ratio of from 5 to 300.
